(19) United States
(12) Patent Application Publication
(10) Pub. No.: US 2013/0070824 A1
(43) Pub. Date: Mar. 21, 2013

(54) RADIO COMMUNICATION ANTENNA AND RADIO COMMUNICATION DEVICE

(71) Applicant: Sang Seok LEE, Daejeon (KR)

(72) Inventor: Sang Seok LEE, Daejeon (KR)

(73) Assignee: Electronics and Telecommunications Research Institute, Daejeon (KR)

(21) Appl. No.: 13/595,707

(22) Filed: Aug. 27, 2012

(30) Foreign Application Priority Data
Sep. 21, 2011 (KR) 10-2011-0095226

(51) Int. Cl. H01Q 7/00; H04B 1/38; H01Q 5/01

(52) U.S. Cl. 375/222; 343/866

(57) ABSTRACT

Disclosed is a radio communication antenna which includes a first conductive line surrounding a closed region on a substrate; and a second conductive line provided within the closed region and directly connected with the first conductive line to be protruded into the closed region. The radio communication antenna has a first communication frequency band and a second communication frequency band different from the first communication frequency band.

### CROSS-REFERENCE TO RELATED APPLICATIONS

A claim for priority under 35 U.S.C. §119 is made to Korean Patent Application No. 10-2011-0095226 filed Sep. 21, 2011, in the Korean Intellectual Property Office, the entire contents of which are hereby incorporated by reference.

### BACKGROUND

The inventive concepts described herein relate to a radio communication antenna and a radio communication device, and more particularly, relate to a loop antenna and a radio communication device including the loop antenna.

Radio communication may be performed by propagating a signal through air and receiving a signal from air without a separate medium (e.g., a conductive line, an optical fiber, etc.) for transmitting a signal. Radio communication technologies may include AM (Amplitude Modulation), FM (Frequency Modulation), PM (Phase Modulation), ASK (Amplitude Shift Keying), FSK (Frequency Shift Keying), PSK (Phase Shift Keying), CDMA (Code Division Multiple Access), OFDM (Orthogonal Frequency Division Multiplexing), and the like.

An antenna may be required to propagate a signal through air and to receive a signal from air. The antenna may be based on a wavelength of a communication frequency. An antenna formed by turning a conductive line at least once may be referred to as a loop antenna. The loop antenna may be used at various communication standards such as RFID (Radio Frequency Identification), Bluetooth, WiFi, and the like.

### SUMMARY

Example embodiments of the inventive concept provide a radio communication antenna comprising a first conductive line surrounding a closed region on a substrate; and a second conductive line provided within the closed region and directly connected with the first conductive line to be protruded into the closed region, wherein the radio communication antenna has a first communication frequency band and a second communication frequency band different from the first communication frequency band.

In example embodiments, the second communication frequency band is varied according to a length and width of the second conductive line.

In example embodiments, the second conductive line has a straight line shape.

In example embodiments, the closed region has a quadrangle shape.

In example embodiments, the second conductive line includes a first side portion, a second side portion, and a third side portion, the second and third side portions connected to both ends of the first side portion and being opposite to each other, the second conductive line is connected to the first side portion, and a distance between the second conductive line and the second side portion is different from a distance between the second conductive line and the third side portion.

Example embodiments of the inventive concept also provide a radio communication device comprising a radio communication antenna; a modem connected with the radio communication antenna and configured to conduct modulation and demodulation; a memory temporarily storing data generated at modulation and demodulation; a user interface receiving information to be modulated from an external device and outputting information generated according to the demodulation to the external device; and a processor controlling the modem, the memory, and the user interface. The radio communication antenna comprises a first conductive line surrounding a closed region on a substrate; and a second conductive line provided within the closed region and directly connected with the first conductive line to be protruded into the closed region. The radio communication antenna has a first communication frequency band and a second communication frequency band different from the first communication frequency band.

In example embodiments, the modem perform radio communication according to a communication standard of the first communication frequency band or according to a communication standard of the second communication frequency band through the radio communication antenna.

### BRIEF DESCRIPTION OF THE FIGURES

The above and other objects and features will become apparent from the following description with reference to the following figures, wherein like reference numerals refer to like parts throughout the various figures unless otherwise specified, and wherein

FIG. 1 is a perspective view of a radio communication antenna 100 according to an embodiment of the inventive concept.

FIG. 2 is a diagram illustrating a communication frequency band of a radio communication antenna according to an embodiment of the inventive concept.

FIG. 3 is a diagram illustrating a communication frequency band of a radio communication antenna according to an embodiment of the inventive concept.

FIG. 4 is a flowchart illustrating a method of fabricating a radio communication antenna.

FIG. 5 is a block diagram illustrating a radio communication device according to an embodiment of the inventive concept.

### DETAILED DESCRIPTION

Embodiments will be described in detail with reference to the accompanying drawings. The inventive concept, however, may be embodied in various different forms, and should not be construed as being limited only to the illustrated embodiments. Rather, these embodiments are provided as examples so that this disclosure will be thorough and complete, and will fully convey the concept of the inventive concept to those skilled in the art. Accordingly, known processes, elements, and techniques are not described with respect to some of the embodiments of the inventive concept. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

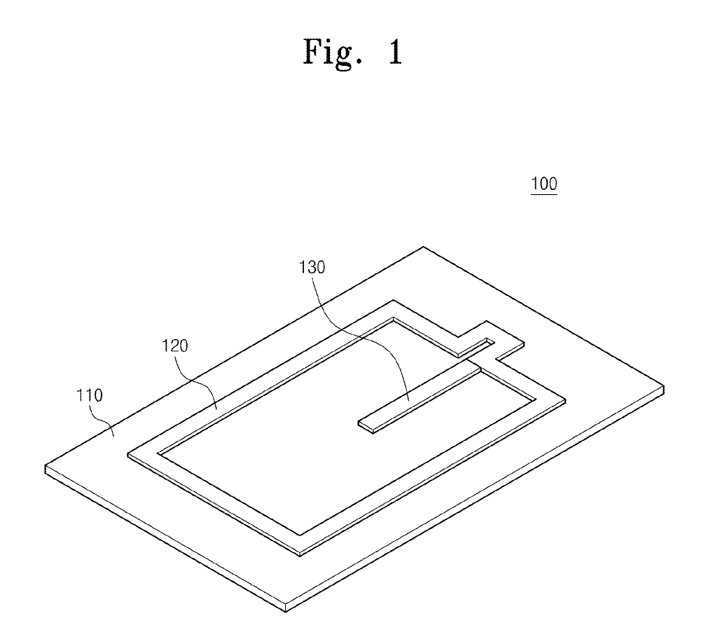

FIG. 1 is a perspective view of a radio communication antenna 100 according to an embodiment of the inventive concept. Referring to FIG. 1, a radio communication antenna 100 may include a substrate 110, a first conductive line 120, and a third conductive line 130.

The substrate 110 may include an insulating material. The first conductive line 120 may be turned once on the substrate 110 to form a loop antenna. The second conductive line 130 may be coupled with one side of the first conductive line 120, and may be provided at a region that is surrounded by the first conductive line 120.

The first conductive line 120 forming a loop antenna may have a first resonant frequency that is determined according to a dielectric permittivity of the substrate 110, a thickness and conductivity of the first conductive line 120, and a width and length of a loop formed by the first conductive line 120. The first resonant frequency of the first conductive line 120 and a frequency band in and around the first conductive line 120 may be a first communication frequency band of the radio communication antenna 100.

The second conductive line 130 may have a second resonant frequency that is determined according to a dielectric permittivity of the substrate 110, a thickness, length, and width of the second conductive line 130, and a location related with the first conductive line 120. The first resonant frequency of the second conductive line 130 and a frequency band in and around the second conductive line 130 may be a second communication frequency band of the radio communication antenna 100.

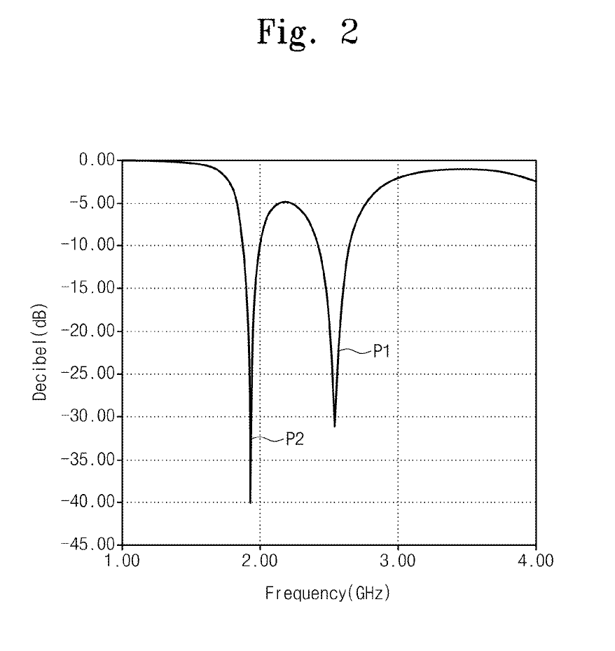

FIG. 2 is a diagram illustrating a communication frequency band of a radio communication antenna according to an embodiment of the inventive concept. Referring to FIGS. 1 and 2, a radio communication antenna 100 may have a first communication band P1 and a second communication band P2. The first communication band P1 may be a communication band according to a first conductive line 120, and the second communication band P2 may be a communication band according to a second conductive line 130. The second communication band P2 may be varied according to a length and width of the second conductive line 130.

The radio communication antenna 100 may have two communication frequency bands. That is, the radio communication antenna 100 may conduct radio communication based on two communication standards having different frequency bands. For example, the radio communication antenna 100 may conduct Bluetooth and WiFi communications using different frequency bands.

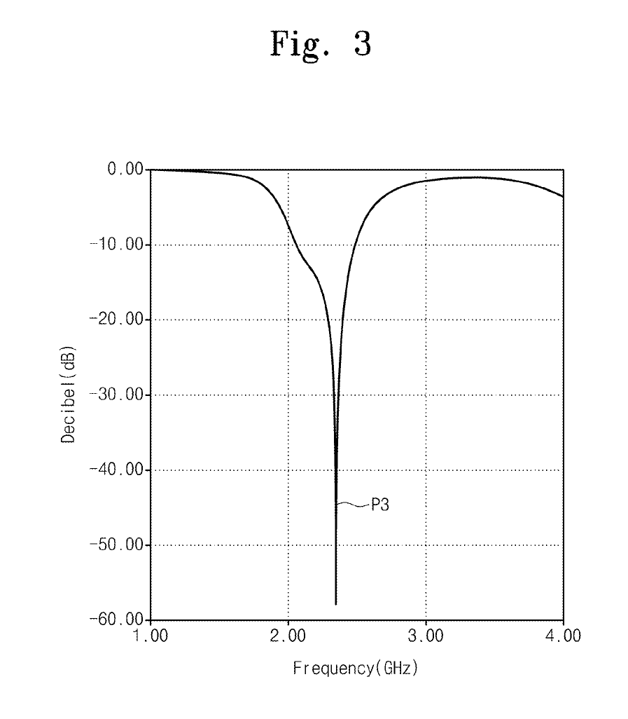

FIG. 3 is a diagram illustrating a communication frequency band of a radio communication antenna according to an embodiment of the inventive concept. Referring to FIGS. 1 and 3, a radio communication antenna 100 may have a third communication frequency band P3. The third communication frequency band P3 may be a communication frequency band according to a first conductive line 120 and a second conductive line 130. As a communication frequency band according to the first conductive line 120 and a communication frequency band according to the second conductive line 130 are overlapped, the third communication frequency band P3 may be wider than a conventional frequency band.

The radio communication antenna 100 may provide a wide communication frequency band. Thus, a data transfer rate of the radio communication antenna 100 may be improved.

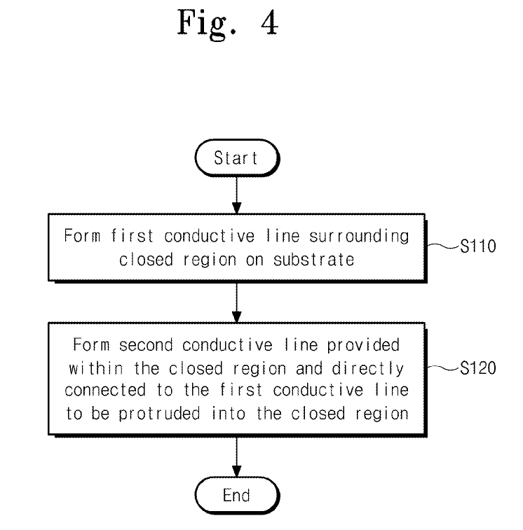

FIG. 4 is a flowchart illustrating a method of fabricating a radio communication antenna. Referring to FIG. 4, in step S110, a first conductive line 120 surrounding a closed region may be formed on a substrate 110. In step S120, a second conductive line 130 may be formed within the closed region to be directly connected to the first conductive line 120 and to be protruded into the closed region. A radio communication antenna 100 according to an embodiment of the inventive concept may be formed to have a first communication frequency band and a second communication frequency band different from the first communication frequency band by forming the first and second conductive lines 120 and 130 on the substrate 110.

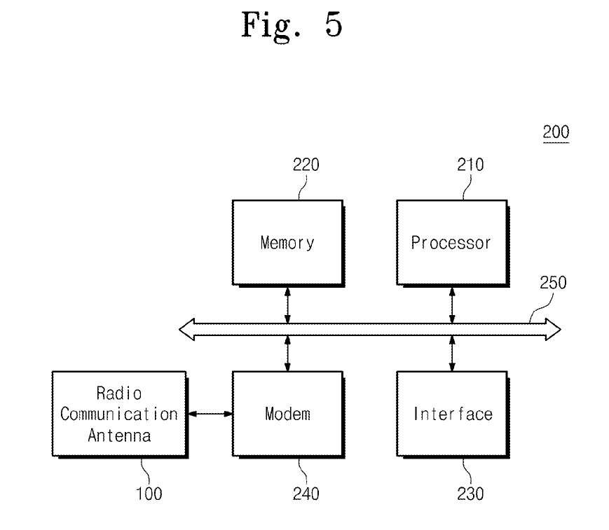

FIG. 5 is a block diagram illustrating a radio communication device according to an embodiment of the inventive concept. Referring to FIG. 5, a radio communication device 200 may include a processor 210, a memory 220, an interface 230, a modem 240, a bus 250, and a radio communication antenna 100.

The processor 210 may control an overall operation of the radio communication device 200. The processor 210 may control the radio communication device 200 to make radio communication.

The memory 220 may be a working memory of the radio communication device 200. The memory 220 may store data to be processed by the processor 210, data processed by the processor 210, data to be modulated by the modem 240, data demodulated by the modem 240, and the like. The memory 220 may include a volatile memory SRAM, DRAM, SDRAM, or the like or a nonvolatile memory such as ROM, PROM, EPROM, EEPROM, flash memory, PRAM (Phase-change RAM), MRAM (Magnetic RAM), RRAM (Resistive RAM), FRAM (Ferroelectric RAM), or the like.

The interface 230 may exchange signals with an external device. For example, the interface 230 may receive data to be transmitted via radio communication from an external device and output data received via radio communication to the external device. The interface 230 may be a communication port for exchanging data with the external device. The interface 230 may include user input interfaces such as a keyboard, a key pad, a touch pad, a button, a mouse, a camera, a microphone, and the like. The interface 230 may include user output interfaces such as a speaker, a monitor, a lamp, a liquid crystal display device, and the like.

The modem 240 may modulate data to be transmitted via radio communication and demodulate data received via radio communication. The modem 240 may perform modulation and demodulation according to communication techniques such as AM (Amplitude Modulation), FM (Frequency Modulation), PM (Phase Modulation), ASK (Amplitude Shift Keying), FSK (Frequency Shift Keying), PSK (Phase Shift Keying), CDMA (Code Division Multiple Access), OFDM (Orthogonal Frequency Division Multiplexing), and the like.

The modem 240 may conduct radio communication according to various radio communication standards such as Bluetooth, WiFi, and the like.

The bus 250 may provide a channel among the elements 210 to 240.

The radio communication antenna 100 may be connected to the modem 240. The radio communication antenna 100 may convert an electric signal transferred from the modem 240 into a radio signal to propagate it through air. The radio communication antenna 100 may convert a radio signal propagated from air into an electric signal to send it to the modem 240.

As described with reference to FIG. 1, the radio communication antenna 100 may include a substrate 110, a first conductive line 120 turned once on the substrate 110 to form a loop antenna, and a second conductive line 130 connected to one side of the first conductive line 120 and provided at a region surrounded by the first conductive line 120.

As described with reference to FIG. 2, the radio communication device 200 may have two communication frequency bands. The radio communication device 200 may perform radio communication according to two communication standards (e.g., Bluetooth and WiFi) using different frequency bands.

As described with reference to FIG. 3, the radio communication device 200 may have a wide communication frequency band. The radio communication device 200 may perform radio communication with a high data transfer rate.

A communication frequency band of the radio communication device 200 may be varied according to a length and width of a second conductive line 130 of the radio communication antenna 100. The radio communication device 200 may have two communication frequency bands or a wide communication frequency band according to a length and width of a second conductive line 130. At least one of two communication frequency bands of the radio communication device 200 may be varied according to a length and width of a second conductive line 130.

While the inventive concept has been described with reference to exemplary embodiments, it will be apparent to those skilled in the art that various changes and modifications may be made without departing from the spirit and scope of the present invention. Therefore, it should be understood that the above embodiments are not limiting, but illustrative.

What is claimed is:

1. A radio communication antenna comprising:
a first conductive line surrounding a closed region on a substrate; and
a second conductive line provided within the closed region and directly connected with the first conductive line to be protruded into the closed region,
wherein the radio communication antenna has a first communication frequency band and a second communication frequency band different from the first communication frequency band.

2. The radio communication antenna of claim 1, wherein the second communication frequency band is varied according to a length and width of the second conductive line.

3. The radio communication antenna of claim 1, wherein the second conductive line has a straight line shape.

4. The radio communication antenna of claim 1, wherein the closed region has a quadrangle shape.

5. The radio communication antenna of claim 1, wherein the second conductive line includes a first side portion, a second side portion, and a third side portion, the second and third side portions connected to both ends of the first side portion and being opposite to each other, the second conductive line is connected to the first side portion, and a distance between the second conductive line and the second side portion is different from a distance between the second conductive line and the third side portion.

6. A radio communication device comprising:
a radio communication antenna;
a modem connected with the radio communication antenna and configured to conduct modulation and demodulation;
a memory temporarily storing data generated at modulation and demodulation;
a user interface receiving information to be modulated from an external device and outputting information generated according to the demodulation to the external device; and
a processor controlling the modem, the memory, and the user interface,
wherein the radio communication antenna comprises:
a first conductive line surrounding a closed region on a substrate; and
a second conductive line provided within the closed region and directly connected with the first conductive line to be protruded into the closed region,
wherein the radio communication antenna has a first communication frequency band and a second communication frequency band different from the first communication frequency band.

7. The radio communication device of claim 6, wherein the modem perform radio communication according to a communication standard of the first communication frequency band or according to a communication standard of the second communication frequency band through the radio communication antenna.
